(19) United States
(12) Patent Application Publication
(10) Pub. No.: US 2013/0250139 A1
(43) Pub. Date: Sep. 26, 2013

(54) Method And System For Tagging And Organizing Images Generated By Mobile Communications Devices

(71) Applicant: Trung Tri Doan, Baoshan Hsinchu (TW)

(72) Inventor: Trung Tri Doan, Baoshan Hsinchu (TW)

(21) Appl. No.: 13/426,688

(22) Filed: Mar. 22, 2012

(51) Int. Cl. H04N 5/76

(52) U.S. Cl. 348/231.3; 348/E05.024

(57) ABSTRACT

A method for tagging and organizing images includes the steps of providing a mobile communication device having an input device configured to receive voice input, an image capture device configured to capture the images of events, a storage medium configured to store the images, and a processor. The method also includes the steps of capturing the images using the image capture device; providing the voice input from the user containing the information; recording the voice input; and forming tagged images in the storage medium using the voice input and the information. A system includes a mobile communications device having a processor in signal communication with an image capture device, with a storage medium and with an input device configured to tag the images with information responsive to voice input and to form tagged images in the storage medium.

### BACKGROUND

This disclosure relates generally to a method and a system for tagging and organizing images generated by mobile communication devices.

Mobile communication devices perform various functions, such as voice communication, e-mail and internet browsing. Mobile communication devices can also include image capture devices, such as digital cameras for generating digital images, such as pictorial images and video images. Due to the convenience and portability of mobile communication devices, it is possible to generate a large number of digital images. These digital images can be stored in the recording medium of the mobile communication device and then transferred to the hard drive of a personal computer for storage, printing, e-mailing or messaging (SMS). The stored digital images can include necessary images, such as good photos or video, and un-necessary images, such as defective, redundant or un-inspiring photos or video.

It is sometimes difficult for the user of a mobile communication device to classify and organize the large number of images generated by the device. Many times the images are taken days or months before one would transfer the images to the hard drive of a personal computer or upload to a server or the cloud for storage. Currently, these images are automatically tagged using date, time and location via GPS coordinate together with the iso, lens information and camera information. In addition, no sounds are recorded except when a video is taken. When the user wants to classify or search for the desired images, the images need to be reviewed one by one. The present disclosure is directed to a method and system for tagging and organizing images generated by mobile communication devices.

### SUMMARY

A method for tagging and organizing images in a mobile communication device, simply stated, comprises using voice input from a user to tag the images and then to later organize and search the images. More particularly, the method includes the steps of providing the mobile communication device with an input device configured to receive user input including voice input, an image capture device configured to capture the images of events, a storage medium configured to store the images, and a processor in signal communication with the image capture device, with the storage medium and with the input device configured to tag the images with information responsive to the voice input. The method also includes the steps of capturing the images using the image capture device; providing the voice input from the user containing the information; recording the voice input; and forming tagged images in the storage medium using the voice input and the information. The method can also include the step of searching the tagged images using the input device, the processor and the information.

A system for tagging and organizing images includes a mobile communication device operable by a user having an input device configured to receive user input, an image capture device configured to capture images of events, a storage medium configured to store the images, and a processor in signal communication with the image capture device, with the storage medium and with the input device configured to tag the images with information and to form tagged images in the storage medium.

### BRIEF DESCRIPTION OF THE DRAWINGS

FIG. 1 is a schematic diagram of a system for tagging and organizing images;

FIG. 2 is a block diagram of a system for tagging and organizing images;

FIG. 3 is a flow diagram of a method for tagging and organizing images in a mobile communication device; and

FIG. 4 is a flow diagram of an alternate method for tagging and organizing images in a mobile communication device.

### DETAILED DESCRIPTION

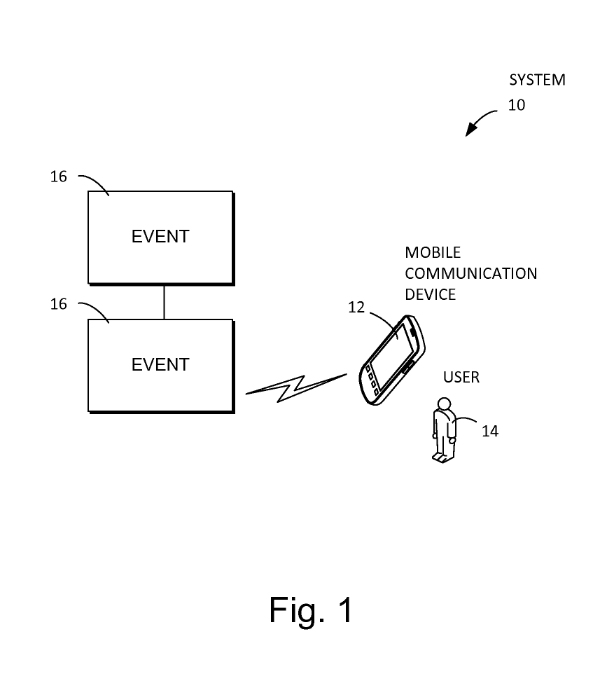

Referring to FIG. 1, a system for tagging and organizing images 10 includes a mobile communication device 12 operable by a user 14. The mobile communication device 12 can comprise any type of device configured to provide communication services to the user 14. For example, the mobile communication device 12 can include a speaker and receiver for providing voice communication services to the user, and a display screen for providing data communications services. Exemplary mobile communications devices include mobile telephones, smart telephones, portable computers, “IPADS” and “IPHONES”.

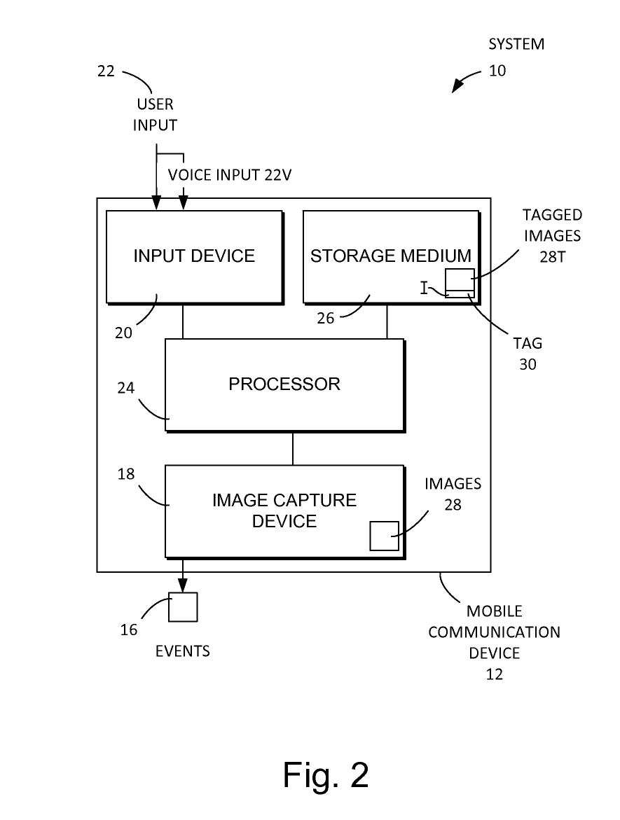

The mobile communication device 12 also includes an image capture device 18 (FIG. 2) configured to generate digital images 28 (FIG. 2) of various events 16. Exemplary image capture devices include digital cameras for generating photographic images and video cameras for generating video images. As used herein, the term “event” means a significant occurrence, happening or subject as perceived by the subjective intent of the user 14.

Referring to FIG. 2, the mobile communication device 12 includes an input device 20 configured to receive user input 22 particularly voice input 22V. For example, the input device 20 can include a voice control operable by the user 14, such as a microphone or a piezo device. However, the input device 20 can also include a keypad, a touch pad, a touch screen, or a reading device, such as a magnetic card reader, an integrated circuit (IC) card reader, or a bar code reader.

Still referring to FIG. 2, the mobile communication device 12 also includes a processor 24 in signal communication with the input device 20 and with the image capture device 18. The processor 24 can comprise a programmable device such as a CPU (central processing device), a PLC (Programmable Logic Controller), or a microprocessor configured to execute computer programs or software. The mobile communication device 12 can be programmed such that the input device 20 responds to voice input 22V to automatically record information (I) from the user 14 whenever the image capture device 18 is activated. This voice input 22V can also be stored in the storage medium 26 and then later used to generate tagged images 28T having tags 30 containing the information (I). The processor 24 can be programmed such that the user 14 has the option of automatically recording the voice input 22V before, during and/or after the image 28 is captured by the image capturing device 18. Also, the processor 24 can be programmed such that the user 14 can set a time limit for capturing the image 28 following the voice input 22V. Preferably, this time limit can be relatively short on the order of second or minutes, with a few minutes or less being exemplary. In addition, to speed up processing and facilitate organizing and recovery of the tagged images 28T, the voice input 22V can be recorded and stored together with the tagged images 28T. In addition, the voice input 22V can be processed further using a voice converting application to convert information on the tagged images 28T for later image search and recovery.

The mobile communication device 12 also includes a storage medium 26 in signal communication with the processor 24 for storing the digital images 28 generated by the image capture device 18. The storage medium 26 can comprise any type of volatile or non-volatile memory such as dynamic random access memory (DRAM), a random access memory (RAM), a flash memory or an application specific integrated circuit (ASIC). In addition, the processor 24 can be configured to transfer the digital images 28 to another device such as a personal computer using a cable or wireless communication (e.g., RF, WIFI or “BLUETOOTH”).

The processor 24 is programmed using suitable software to receive the user input 22 and to generate the tagged images 28T, which are searchable and recoverable from the storage medium 26 with appropriate user input 22. Each tagged image 28T includes the tag 30 that identifies the tagged image 28T with the information (I). Preferably, the tag 30 is relatively small in size relative to the size of the tagged image 28T. In addition, the tag 30 can be contained within the boundaries of the tagged image 28T, or outside of the boundaries, such as along an edge of the tagged image 28T. The information (I) on each tag 30 can be used for searching and for organizing the tagged images 28T generated by the image capture device 18, the user input 22 and the processor 24 operated in concert. For example, the tag 30 can include information (I) representative of a characteristic, a nature or a state of the tagged image 28T.

In the past, images have typically been tagged with information such as time, date, location, GPS coordinates, and technical information, such as shutter speed and aperture speed. However this information does not enable the user 14 to efficiently search for a particular image. In contrast, the system 10 is configured to select the information (I) on the tag 30 that enables a user to more efficiently retrieve a particular image, particularly hours or days after the events 16. For example, the information (I) can include the name of an event or a comment relating to an event. Specific examples include a person's name (e.g., Kim my wife), a person's mood or actions (e.g., smiling, crying, drinking, eating) or a setting (e.g., koi pond, LED lighted bridge, apple tree). In addition to providing the information (I) for the tagged images 28T, the voice input 22V can be used to generate search words for future searching, or for automatically placing the tagged image 28T in a folder location in the storage medium 26 or a server for future searches.

The input device 20 can be configured to input the voice input 22V into the processor 24 contemporaneously with capture of the image 28, or after the image 28 is captured. As another alternative, the processor 24 can be preprogrammed such that in a default condition, certain information is automatically inputted. For example, information can be automatically placed on the tagged images 28T absent the input of voice input 22V, and used to tie together or assemble single or multiple files in the same sequence.

The processor 24 can also be programmed to search and organize the tagged images 28T as a function of the information (I) contained on the tags 30. For example, key words can be transmitted as user input 22 into the processor 24 and used to assemble the tagged images 28T containing the key words. The selected tagged images 28T can then be placed in a folder or bookmarked on the storage medium 26, and then downloaded from the storage medium 26 if desired. For example, the tagged images 28T can be transferred to another device, such as a personal computer configured to search and organize the tagged images 28T as a function of the information (I) contained on the tags 30.

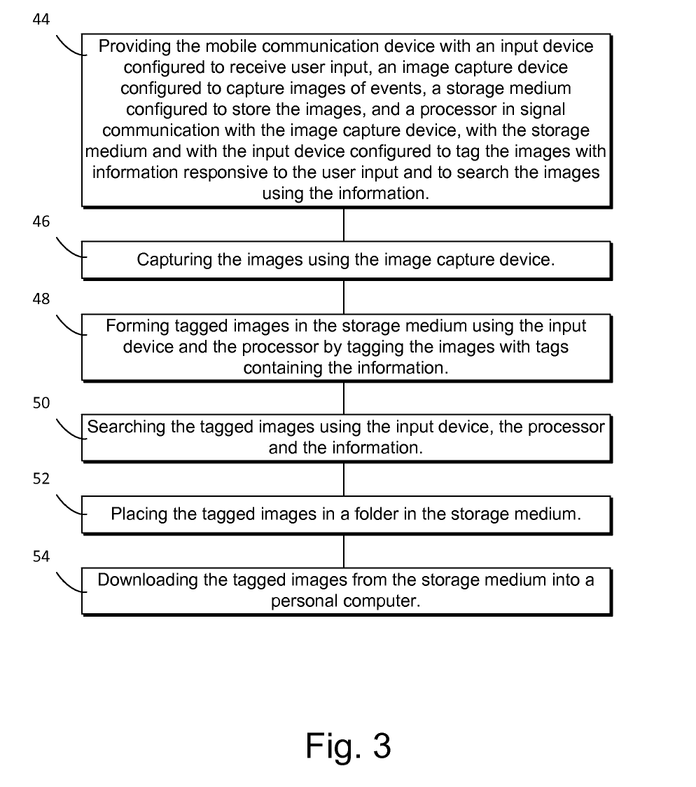

Referring to FIG. 3, steps in a method for tagging and organizing images in a mobile communication device operable by a user are illustrated.

The method includes the step of providing the mobile communication device with an input device configured to receive user input, an image capture device configured to capture images of events, a storage medium configured to store the images, and a processor in signal communication with the image capture device, with the storage medium and with the input device configured to tag the images with information responsive to the user input and to search the images using the information, step 32.

The method also includes the step of capturing the images using the image capture device, step 34.

The method also includes the step of forming tagged images in the storage medium using the input device and the processor by tagging the images with tags containing the information, step 36. Preferably, the information is transmitted by the user into the processor contemporaneously or within a short time period after the images are generated by the image capture device. This allows the user to form the tagged images responsive to a criteria, such as the importance of the event or the quality of the image, as perceived during image capture. For example, the information can preferably be inputted within one second to five minutes, more preferably from one second to one minute, and most preferably from one second to thirty seconds after the images are generated. This step can also be performed by automatic input of information in a default condition, such as with no voice input by the user.

The method also includes the step of searching the tagged images using the input device, the processor and the information, step 38. For example, the information can include key words. These key words can be used to search all of the tagged images and to identify the tagged images containing the key words.

The method can also include the step of placing the tagged images in a folder in the storage medium, step 40. Alternately, rather than placing the tagged images in a folder, selected tagged images can be bookmarked for future viewing.

The method can also include the step of downloading the tagged images from the storage medium into a personal computer, step 42. In this case the personal computer can be programmed to search the tagged images and to organize the tagged images into separate folders.

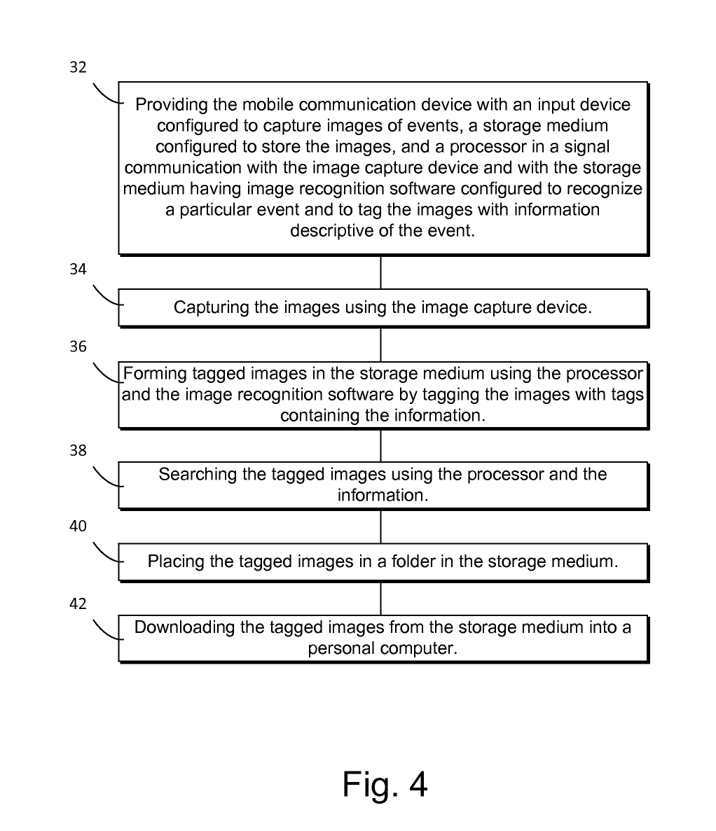

Referring to FIG. 4, steps in an alternate method for tagging and organizing images in a mobile communication device operable by a user are illustrated. The method is substantially similar to the method of FIG. 3. However, rather than using user input 22, the processor 24 can be programmed to automatically generate the tagged images 28T using image recognition software. For example, image recognition software can be used to identify a particular event such as a particular subject (e.g., car, bridge, tree, man, woman). This process can be performed before the image 28 of the event 16 is captured, after the image 28 is captured, or within a specific time period within capture of the image 28 by the image capture device 18.

The alternate method includes the step of providing the mobile communication device with an image capture device configured to capture images of events, a storage medium configured to store the images, and a processor in signal communication with the image capture device and with the storage medium having image recognition software configured to recognize a particular event and to tag the images with information descriptive of the event, step 44.

The alternate method also includes the step of capturing the images using the image capture device, step 46.

The alternate method also includes the step of forming tagged images in the storage medium using the processor and the image recognition software by tagging the images with tags containing the information, step 48.

The alternate method also includes the step of searching the tagged images using the processor and the information, step 50.

The alternate method can also include the step of placing the tagged images in a folder in the storage medium, step 52. Alternately rather than placing the tagged images in a folder selected tagged images can be bookmarked for future viewing.

The alternate method can also include the step of downloading the tagged images from the storage medium into a personal computer, step 54. In this case the personal computer can be programmed to search the tagged images and to organize the tagged images into separate folders.

Thus the disclosure describes a method and a system for tagging and organizing images in a mobile communication device. While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A method for tagging and organizing images in a mobile communication device operable by a user comprising:
providing the mobile communication device with an input device configured to receive user input including voice input, an image capture device configured to capture the images of events, a storage medium configured to store the images, and a processor in signal communication with the image capture device, with the storage medium and with the input device configured to tag the images with information responsive to the voice input;
capturing the images using the image capture device;
providing the voice input from the user containing the information;
recording the voice input; and
forming tagged images in the storage medium using the voice input and the information.

2. The method of claim 1 wherein the recording the voice input step is performed automatically by the processor within a set time period after the capturing the images step.

3. The method of claim 1 wherein following the providing the voice input step, the capturing the images step is performed within a set time limit.

4. The method of claim 1 further comprising searching the tagged images using the input device, the processor and the information.

5. The method of claim 1 wherein the providing the voice input step is performed within minutes of the capturing the images step.

6. The method of claim 1 wherein the providing the voice input step is performed before the capturing the images step.

7. The method of claim 1 further comprising using a voice converting application to convert the information on the tagged images for later image search and recovery.

8. The method of claim 1 wherein the user input comprises preprogrammed data and the processor is configured to use the preprogrammed data during the tagged images step.

9. The method of claim 1 wherein the information comprises an element selected from the group consisting of a person's name, a person's mood, a person's actions, and a setting.

10. The method of claim 1 further comprising placing the tagged images in a folder in the storage medium searchable using key words.

11. The method of claim 1 further comprising downloading the tagged images from the storage medium into a personal computer.

12. The method of claim 1 wherein the mobile communication device comprises a device selected from the group consisting of mobile phones, smart phones and portable computers.

13. The method of claim 1 wherein the input device comprises a voice control or a piezo device.

14. The method of claim 1 wherein the tagged images comprise tags within boundaries thereof or along outside boundaries thereof.

15. The method of claim 1 wherein the forming the tagged images step is performed automatically by preprogramming the processor.

16. A system for tagging and organizing images comprising:
a mobile communication device operable by a user comprising:
an input device configured to receive user input including voice input;
an image capture device configured to capture images of events;
a storage medium configured to store the images; and
a processor in signal communication with the image capture device, with the storage medium and with the input device configured to tag the images with information responsive to the voice input to form tagged images in the storage medium and to search the tagged images using the information.

17. The system of claim 16 wherein the input device comprises a voice control device or a piezo device.

18. The system of claim 16 wherein the tagged images contain tags within the boundaries thereof or along outside boundaries thereof.

19. The system of claim 16 wherein the mobile communication device comprises a device selected from the group consisting of mobile phones, smart phones and portable computers.

20. The system of claim 16 wherein the information comprises an element selected from the group consisting of a person's name, a person's mood, a person's actions, and a setting.

21. A method for tagging and organizing images in a mobile communication device operable by a user comprising:
providing the mobile communication device with an image capture device configured to capture images of events, a storage medium configured to store the images, and a processor in signal communication with the image capture device and with the storage medium having image recognition software configured to recognize a particular event and to tag the images with information descriptive of the event;
capturing the images using the image capture device;
forming tagged images in the storage medium using the processor and the image recognition software by tagging the images with tags containing the information;
searching the tagged images using the processor and the information; and
placing the tagged images in a folder in the storage medium.

22. The method of claim 21 further comprising downloading the tagged images from the storage medium into a personal computer.

23. The method of claim 21 wherein the information comprises an element selected from the group consisting of a person's name, a person's mood, a person's actions, and a setting.

24. The method of claim 21 wherein the mobile communication device comprises a device selected from the group consisting of portable phones, cell phones and portable computers.
